(19) United States
(12) Patent Application Publication
(10) Pub. No.: US 2014/0292739 A1
(43) Pub. Date: Oct. 2, 2014

(54) ORGANIC LIGHT EMITTING DISPLAY DEVICE AND METHOD FOR DRIVING THE SAME

(71) Applicants: Hyun-Min KIM, Yongin-City (KR); Jae-Woo RYU, Yongin-City (KR); Hyun-Chul SON, Yongin-City (KR); Sung-Kook KIM, Yongin-City (KR)

(72) Inventors: Hyun-Min KIM, Yongin-City (KR); Jae-Woo RYU, Yongin-City (KR); Hyun-Chul SON, Yongin-City (KR); Sung-Kook KIM, Yongin-City (KR)

(21) Appl. No.: 13/945,062

(22) Filed: Jul. 18, 2013

(30) Foreign Application Priority Data
Apr. 2, 2013 (KR) 10-2013-0035923

(51) Int. Cl. G09G 3/32

(52) U.S. Cl. CPC G09G 3/3283
USPC 345/212; 345/76

(57) ABSTRACT

An organic light emitting display device includes a pixel unit including a plurality of pixels, the plurality of pixels being disposed at intersections of data lines with scan lines, a data driver configured to supply data signals to the data lines, a scan driver configured to sequentially supply scan signals to the scan lines, a power supply unit configured to supply a first power to the pixel unit through first power supply lines and a second power to the pixel unit through second power supply lines, and a current controller configured to maintain current values of the first power supply lines to be lower than a reference value by controlling resistance values of the first power supply lines according to current values of the first power supply lines.

### CROSS-REFERENCE TO RELATED APPLICATION

Korean Patent Application No. 10-2013-0035923 filed on Apr. 2, 2013, in the Korean Intellectual Property Office, and entitled: “ORGANIC LIGHT EMITTING DISPLAY DEVICE AND METHOD FOR DRIVING THE SAME,” is incorporated by reference herein in its entirety.

### BACKGROUND

1. Field

Embodiments relate to an organic light emitting display device and a method for driving the same.

2. Description of the Related Art

Recently, various flat panel displays capable of reducing weight and volume, which are disadvantages of a cathode ray tube, have been developed. Examples of flat panel displays may include a liquid crystal display, a field emission display, a plasma display panel, an organic light emitting display, and the like.

Among the flat panel displays, the organic light emitting display displays an image using an organic light emitting diode (OLED) generating light by recombination of electrons and holes. Such an organic light emitting display has a fast response speed and is driven at a low power. Generally, in the organic light emitting display, a driving transistor included in each pixel supplies a current having a magnitude corresponding to a data signal to the OLED, thereby generating the light in the OLED.

### SUMMARY

Embodiments relate to an organic light emitting display device and a method for operating the same that include a current controller configured to control current values of a plurality of power supply lines supplying power to a pixel unit to prevent an increase in temperature in the plurality of power supply lines.

According to an exemplary embodiment, there is provided an organic light emitting display including a pixel unit including a plurality of pixels, the plurality of pixels being disposed at intersections of data lines with scan lines, a data driver configured to supply data signals to the data lines, a scan driver configured to sequentially supply scan signals to the scan lines, a power supply unit configured to supply a first power to the pixel unit through first power supply lines and a second power to the pixel unit through second power supply lines, and a current controller configured to maintain current values of the first power supply lines to be lower than a reference value by controlling resistance values of the first power supply lines according to current values of the first power supply lines.

The current controller may include a plurality of resistor controllers configured to measure current values of corresponding first power supply lines, and to control corresponding resistance value of the first power supply lines based on the measured current values.

Each of the plurality of resistor controllers may include a current measurer connected in series to a corresponding first power supply line, the current measurer being configured to measure the current value of the corresponding first power supply line and to output the measured current value, and a digital resistor connected in series to the current measurer, the digital resistor being figured to control the resistance value in response to the measured current value.

The digital resistor may be configured to increase the resistance value in proportion to the measured current value.

The current controller may include a plurality of positive temperature coefficient thermistors coupled in series to corresponding first power supply lines.

A resistance value of each of the plurality of positive temperature coefficient thermistors may increase in proportion to heat generated by the current flowing through the corresponding first power supply lines.

The first power may be any one of an input power and a base power, and the second power is the other one of the input power and the base power.

Each of the first power supply lines may be configured to supply the first power only to a corresponding partial area of an entire area of the pixel unit.

According to another exemplary embodiment, there is provided a method for operating an organic light emitting display device having a data driver supplying data signals to the data lines and a scan driver sequentially supplying scan signals to the scan lines, the method including supplying a first power from a power supply unit to a pixel unit through first power supply lines, the pixel unit including a plurality of pixels at intersections of data lines with scan lines, supplying a second power from the power supply unit to the pixel unit through second power supply lines, and controlling resistance values of the first power supply lines according to current values of the first power supply lines by maintaining the current values of the first power supply lines to be lower than a reference value.

Maintaining the current values of the first power supply lines to be lower than the reference value includes measuring the current values of the first power supply lines, and controlling the resistance value of the first power supply lines based on the measured current values.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic view of an organic light emitting display device according to an exemplary embodiment.

FIG. 2 illustrates a detailed schematic view of a current controller according to an exemplary embodiment.

FIG. 3 illustrates a detailed schematic view of a current controller according to another exemplary embodiment.

FIG. 4 illustrates a flowchart of a method for operating an organic light emitting display according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

Hereinafter, preferred embodiments will be described in detail with reference to the accompanying drawings.

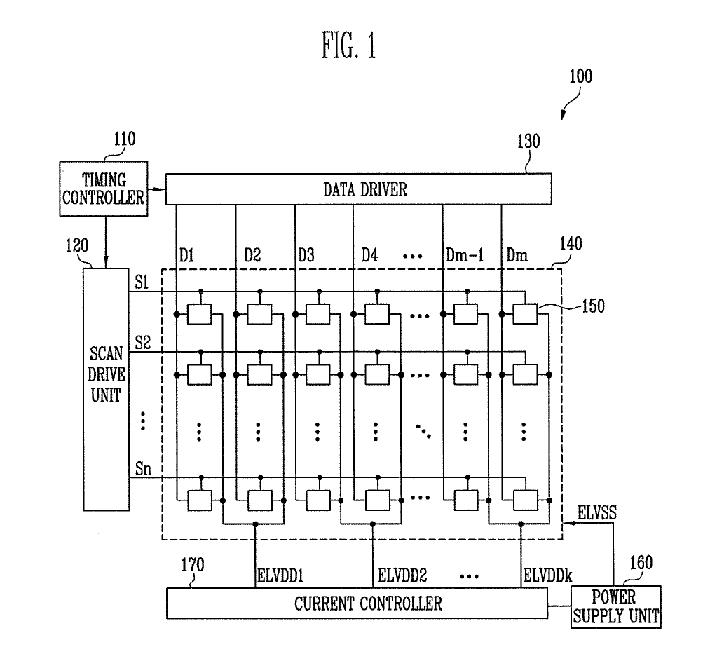

FIG. 1 is a schematic view showing an organic light emitting display device according to an exemplary embodiment.

Referring to FIG. 1, an organic light emitting display 100 may include a timing controller 110, a scan drive unit 120, a data driver 130, a pixel unit 140, a power supply unit 160, and a current controller 170.

The timing controller 110 controls operations of the scan drive unit 120 and the data driver 130 and rearranges data supplied from the outside to output to the data driver 130. In detail, the timing controller 110 generates a scan drive control signal and supplies the generated scan drive control signal to the scan drive unit 120, and generates a data drive control signal and supplies the generated data drive control signal to the data driver 130, in response to a sync signal (not shown) supplied from the outside.

The scan drive unit 120 sequentially supplies scanning signals to the pixel unit 140 through the scan lines S1 to Sn according to the control of the timing controller 110, i.e., in response to the scan drive control signal output from the timing controller 110.

The data driver 130 sequentially supplies data signals to the pixel unit 140 through the data lines D1 to Dm according to the control of the timing controller 110, i.e., in response to the data drive control signal output from the timing controller 110.

The pixel unit 140 includes pixels 150, e.g., arranged in a matrix form having a plurality of row lines and a plurality of column lines. The pixels 150 are disposed in portions at which the scan lines S1 to Sn and data lines D1 to Dm intersect with each other.

Each of the pixels 150 emit light having luminance corresponding to the data signal supplied through the corresponding data line among data lines D1 to Dm, in response to the scan signal supplied through the corresponding scanning line among the scan lines S1 to Sn. The pixels 150 emit the light with various colors, e.g., red, green, blue, white or the like, according to a type of an organic light emitting diode (not shown) included in each of the pixels 150 or according to a color of a color filter formed on the organic light emitting diode.

The power supply unit 160 supplies power to the pixel unit 140 through a plurality of power supply lines ELVDD1 to ELVDDk and ELVSS. In detail, the power supply unit 160 supplies a first power through first power supply lines ELVDD1 to ELVDDk and supplies a second power through second power supply lines ELVSS. The first power may be any one of an input power and a base power, and the second power may be the other one of the input power and the base power. The input power has a voltage value higher than that of the base power.

The organic light emitting diode emits light by current flowing to the base power from the input power through the organic light emitting diode. It is noted that hereinafter, e.g., with reference to FIG. 1, although example embodiments are described in connection with a case in which the first power is the input power and the second power is the base power, example embodiments are not limited thereto.

Referring to FIG. 1, each of the first power supply lines ELVDD1 to ELVDDk supplies the first power to a corresponding partial area of the entire area of the pixel unit 140. For example, as shown in FIG. 1, a power supply line, e.g., supply line ELVDD1, may supply the first power to pixels of two columns. A number of the first power supply lines ELVDD1 to ELVDDk or a configuration of the connection structure of the first power supply lines ELVDD1 to ELVDDk to the pixels 150 may be variously changed according to a design scheme of the designer.

The current controller 170 is connected between the pixel unit 140 and the power supply unit 160. The current controller 170 controls resistance values of the first power supply lines ELVDD1 to ELVDDk according to the current values of the first power supply lines ELVDD1 to ELVDDk. Therefore, the current controller 170 may maintain the current values of the first power supply lines ELVDD1 to ELVDDk to be lower than a reference value. For example, when the current value of the power supplied from the power supply unit 160 is constant but only predetermined ones of the first power supply lines ELVDD1 to ELVDDk transmit power, e.g., only to pixels emitting light to display an image, the current controller 170 may control resistance values of the predetermined ones of the first power supply lines ELVDD1 to ELVDDk to prevent an increase in temperature in the plurality of the first power supply lines ELVDD1 to ELVDDk.

For example, the current controller 170 decreases the current value of the k-th first power supply line ELVDDk by increasing the resistance value of the k-th first power supply line ELVDDk, when the current value of any one of the first power supply lines, e.g., the k-th first power supply line ELVDDk, increases. In this case, the current value supplied to other first power supply lines increases as much as the current value decreased in the k-th first power supply line ELVDDk. In another example, the current controller 170 increases the current value of the k-th first power supply line ELVDDk by decreasing the resistance value of the k-th first power supply line ELVDDk, when the current value of the k-th first power supply line ELVDDk decreases.

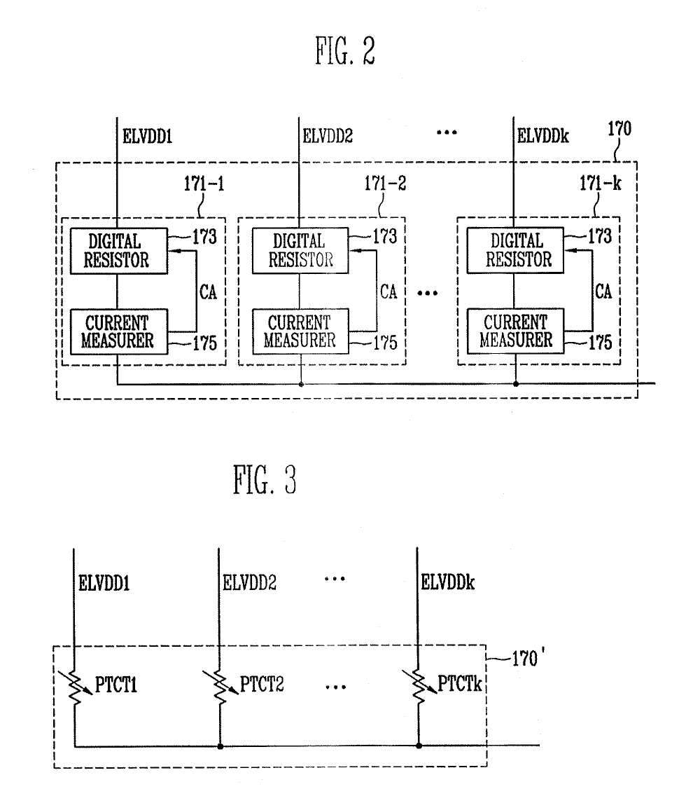

FIG. 2 is a detailed view of a first exemplary embodiment of the current controller 170. Referring to FIGS. 1 and 2, the current controller 170 may include a plurality of resistor controllers 171-1 to 171-k.

Each of the plurality of resistor controllers 171-1 to 171-k measures a current value of a corresponding power supply line among the first power supply lines ELVDD1 to ELVDDk, and controls a resistance value of the corresponding power supply line according to the measured current value. Each of the plurality of resistor controllers 171-1 to 171-k includes a current measurer 175 and a digital resistor 173. The current measurer 175 and the digital resistor 173 are connected to the corresponding power supply line in series.

Each of the current measurers 175 measures the current value of the corresponding power supply line connected thereto, and outputs the measured current value CA. The digital resistor 173 controls its own resistance value, i.e., controls and adjusts self-resistance of the digital resistor 173, in response to the output current value CA from the current measurer 175. That is, the digital resistor 173 increases its resistance value when the measured current value CA is increased, and decreases its resistance value when the measured current value CA is decreased. A change rate in the resistance value of the digital resistor 173 is determined, so that the current value of the corresponding power supply line may be maintained to be lower than the reference value all the time.

FIG. 3 is a detailed view of a second exemplary embodiment of the current controller shown in FIG. 1. Referring to FIGS. 1 and 3, a current controller 170′ may include a plurality of positive temperature coefficient thermistors PTCT1 to PTCTk. Each of the plurality of positive temperature coefficient thermistors PTCT1 to PTCTk is connected to a corresponding power supply line among the first power supply lines ELVDD1 to ELVDDk in series.

In detail, in accordance with increased current values of the first power supply lines ELVDD1 to ELVDDk, the temperature of the first power supply lines ELVDD1 to ELVDDk and the temperature of the positive temperature coefficient thermistors PTCT1 to PTCTk increases. Further, in accordance with increased temperature of the plurality of positive temperature coefficient thermistors PTCT1 to PTCTk, the resistance values of the positive temperature coefficient thermistors PTCT1 to PTCTk increases in accordance with the increased temperature. Therefore, in the plurality of positive temperature coefficient thermistors PTCT1 to PTCTk, the resistance value thereof increases in accordance with increased current values of the first power supply lines ELVDD1 to ELVDDk.

For example, heat is generated by current flowing through the k-th first power supply line ELVDDk. When the current value of the k-th first power supply line ELVDDk increases, the temperature of the k-th first power supply line ELVDDk increases. Further, when the temperature of the k-th first power supply line ELVDDk increases, the resistance value of the k-th positive temperature coefficient thermistor PTCTk increases. Accordingly, the current value of the k-th first power supply line ELVDDk may be controlled, e.g., the current may be decreased in response to the increased resistance, such that the k-th first power supply line ELVDDk may be maintained with a current value lower than the reference value.

In another example, when the current value of the k-th first power supply line ELVDDk decreases, the temperature of the k-th first power supply line ELVDDk decreases. Further, when the temperature of the k-th first power supply line ELVDDk decreases, the resistance value of the k-th positive temperature coefficient thermistor PTCTk decreases. Therefore, the current value of the k-th first power supply line ELVDDk may increase in response to the decreased resistance.

A change rate of the resistance value in the plurality of positive temperature coefficient thermistors PTCT1 to PTCTk is determined so that the current value of the corresponding power supply line may be maintained to be lower than the reference value all the time.

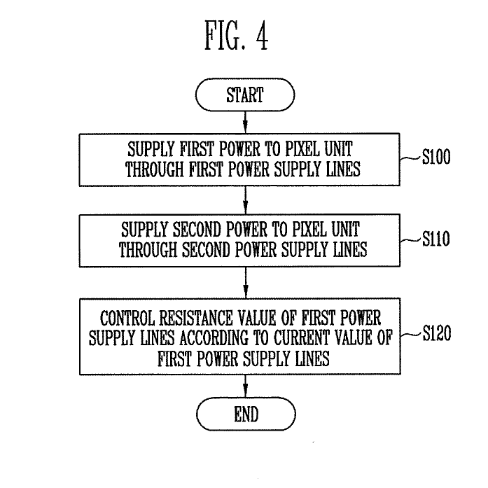

FIG. 4 is a flowchart describing a method for operating an organic light emitting display according to an exemplary embodiment.

Referring to FIGS. 1 and 4, the power supply unit 160 supplies the first power to the pixel unit 140 through the first power supply lines ELVDD1 to ELVDDk (S100), and supplies the second power to the pixel unit 140 through the second power supply line ELVSS (S110).

The current controller 170 controls the resistance values of the first power supply lines ELVDD1 to ELVDDk according to the current values of the first power supply lines ELVDD1 to ELVDDk to maintain the current values of the first power supply lines ELVDD1 to ELVDDk to be lower than the reference value (S120).

According to the exemplary embodiment, the current controller 170 includes a plurality of resistance controllers 171-1 to 171-k including the current measurers 175 and the digital resistors 173. The current measurer 175 measures the current values of the first power supply lines ELVDD1 to ELVDDk, and the digital resistor 173 controls the first power supply lines ELVDD1 to ELVDDk based on the measured current values. According to another exemplary embodiment, the current controller 170 includes the plurality of positive temperature coefficient thermistors PTCT1 to PTCTk, in which the resistance values are controlled in proportion to the temperature increase (due to current) in the first power supply lines ELVDD1 to ELVDDk.

Although the current controller 170 is implemented in the organic light emitting display 100 according to the exemplary embodiments, the exemplary embodiments are not limited thereto. For example, the current controller 170 may be implemented in various displays supplying power through a plurality of power supply lines.

The organic light emitting display and the method for operating the same according to the exemplary embodiment prevent an increase in temperature in the plurality of power supply lines by controlling current values of the plurality of power supply lines supplying power to the pixel unit. Therefore, it may be possible to prevent defects and malfunction of the pixel unit.

In contrast, when a pixel unit of a conventional organic light emitting display, e.g., an organic light emitting display without current control of the power supply lines, receives power through multiple supply lines and the current value of the power supplied from the power supply unit is constant, the current value of individual power supply lines may increase when not all pixels are operational. For example, the input power and the base power from the power supply unit may be supplied to the pixel unit through a plurality of power supply lines connected to respective predetermined partial areas of the pixel unit, so when only predetermined pixels of the pixel unit (in accordance with a displayed image) are lit, the current may flow into only some of the power supply lines among the plurality of the power supply lines. Since the current value of the power supplied from the power supply unit is constant, the current value of the partial power supply lines (connected to the operational pixels) may be increased. As a result, the temperature of the partial power supply lines may increase, and an image quality of the image displayed thereon may deteriorate, such that a defect and a malfunction of the pixel unit may be generated.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An organic light emitting display device, comprising:
a pixel unit including a plurality of pixels, the plurality of pixels being disposed at intersections of data lines with scan lines;
a data driver configured to supply data signals to the data lines;
a scan driver configured to sequentially supply scan signals to the scan lines;
a power supply unit configured to supply a first power to the pixel unit through first power supply lines and a second power to the pixel unit through second power supply lines; and
a current controller configured to maintain current values of the first power supply lines to be lower than a reference value by controlling resistance values of the first power supply lines according to current values of the first power supply lines.

2. The organic light emitting display device of claim 1, wherein the current controller includes a plurality of resistor controllers configured to measure current values of corresponding first power supply lines, and to control corresponding resistance value of the first power supply lines based on the measured current values.

3. The organic light emitting display device of claim 2, wherein each of the plurality of resistor controllers includes:
a current measurer connected in series to a corresponding first power supply line, the current measurer being configured to measure the current value of the corresponding first power supply line and to output the measured current value; and
a digital resistor connected in series to the current measurer, the digital resistor being figured to control the resistance value in response to the measured current value.

4. The organic light emitting display device of claim 3, wherein the digital resistor is configured to increase the resistance value in proportion to the measured current value.

5. The organic light emitting display device of claim 1, wherein the current controller includes a plurality of positive temperature coefficient thermistors coupled in series to corresponding first power supply lines.

6. The organic light emitting display device of claim 5, wherein a resistance value of each of the plurality of positive temperature coefficient thermistors increases in proportion to heat generated by the current flowing through the corresponding first power supply lines.

7. The organic light emitting display device of claim 1, wherein the first power is any one of an input power and a base power, and the second power is the other one of the input power and the base power.

8. The organic light emitting display device of claim 1, wherein each of the first power supply lines is configured to supply the first power only to a corresponding partial area of an entire area of the pixel unit.

9. A method for operating an organic light emitting display device having a data driver supplying data signals to the data lines and a scan driver sequentially supplying scan signals to the scan lines, the method comprising:
supplying a first power from a power supply unit to a pixel unit through first power supply lines, the pixel unit including a plurality of pixels at intersections of data lines with scan lines;
supplying a second power from the power supply unit to the pixel unit through second power supply lines; and
controlling resistance values of the first power supply lines according to current values of the first power supply lines by maintaining the current values of the first power supply lines to be lower than a reference value.

10. The method of claim 9, wherein maintaining the current values of the first power supply lines to be lower than the reference value includes:
measuring the current values of the first power supply lines; and
controlling the resistance value of the first power supply lines based on the measured current values.
